(19) United States
(12) Patent Application Publication
(10) Pub. No.: US 2022/0078748 A1
(43) Pub. Date: Mar. 10, 2022

(54) PAGING FOR SYSTEMS SUPPORTING PHYSICAL (PHY) LAYER AND MEDIUM ACCESS CONTROL (MAC) LAYER MOBILITY

(71) Applicant: QUALCOMM Incorporated, San Diego, CA (US)

(72) Inventors: Jelena DAMNJANOVIC, Del Mar, CA (US); Tao LUO, San Diego, CA (US); Aleksandar DAMNJANOVIC, Del Mar, CA (US)

(21) Appl. No.: 17/466,650

(22) Filed: Sep. 3, 2021

Related U.S. Application Data
(60) Provisional application No. 63/076,331, filed on Sep. 9, 2020.

(51) Int. Cl. H04W 68/00; H04W 72/04

(52) U.S. Cl. CPC H04W 68/005; H04W 72/04

(57) ABSTRACT

Aspects of the present disclosure relate to wireless communications, and more particularly, to techniques that allow for paging UEs with updates to system information for cells that support physical (PHY) or medium access control (MAC) layer mobility. An example method generally includes receiving one or more signals configuring the UE with a set of cells that support physical (PHY) layer or medium access control (MAC) layer mobility, receiving paging message including an indication that an update to system information is available, and communicating with one or more of the set of cells based on the updated system information.

### CROSS-REFERENCE TO RELATED APPLICATIONS

This application claims benefit to U.S. Provisional Patent Application Ser. No. 63/076,331, entitled “Paging for Systems Supporting Physical (PHY) Layer and Medium Access Control (MAC) Layer Mobility,” filed Sep. 9, 2020, and assigned to the assignee hereof, the contents of which are hereby incorporated by reference in its entirety.

### TECHNICAL FIELD

Aspects of the present disclosure relate to wireless communications, and more particularly, to techniques that allow for paging of devices that support physical (PHY) layer and/or medium access control (MAC) layer mobility.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (for example, bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (for example, 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE.

### SUMMARY

The systems, methods, and devices of the disclosure each have several innovative aspects, no single one of which is solely responsible for the desirable attributes.

One innovative aspect of the subject matter described in this disclosure can be implemented in a method for wireless communication by a user equipment (UE). The method generally includes receiving one or more signals configuring the UE with a set of cells that support physical (PHY) layer or medium access control (MAC) layer mobility, receiving paging message including an indication that an update to system information is available, and communicating with one or more of the set of cells based on the updated system information

One innovative aspect of the subject matter described in this disclosure can be implemented in a method for wireless communication by a network entity. The method generally includes transmitting, to a user equipment (UE), signaling one or more signals configuring the UE with a set of cells that support physical (PHY) layer or medium access control (MAC) layer mobility, transmitting, to the UE, a paging message indicating that an update to system information is available, and communicating with the UE based on the updated system information.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail some illustrative features of the one or more aspects. These features are indicative, however, of but a few of the various ways in which the principles of various aspects may be employed.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows an example wireless communication network in which some aspects of the present disclosure may be performed.

FIG. 2 shows a block diagram illustrating an example base station (BS) and an example user equipment (UE) in accordance with some aspects of the present disclosure.

FIG. 3A illustrates an example of a frame format for a telecommunication system.

FIG. 3B illustrates how different synchronization signal blocks (SSBs) may be sent using different beams.

FIG. 4 illustrates an example architecture in which aspects of the present disclosure may be practiced.

FIGS. 5 and 6 illustrate example scenarios in which aspects of the present disclosure may be practiced.

FIGS. 7A and 7B illustrate an example of UE mobility, in accordance with some aspects of the present disclosure.

FIG. 8 illustrates an example of radio units that support multiple carriers, in accordance with some aspects of the present disclosure.

FIG. 9 illustrates example operations for wireless communication by a user equipment (UE), in accordance with some aspects of the present disclosure.

FIG. 10 illustrates example operations for wireless communication by a network entity, in accordance with some aspects of the present disclosure.

FIG. 11 is a call flow diagram illustrating messages exchanged between a user equipment (UE) and a network entity for updating system information based on information in paging messages, in accordance with some aspects of the present disclosure.

FIG. 12 illustrates a communications device that may include various components configured to perform operations for the techniques disclosed herein in accordance with aspects of the present disclosure.

FIG. 13 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques that allow for paging of devices that support physical (PHY) layer and/or medium access control (MAC) layer mobility. As will be described in greater detail below, for cells that support physical (PHY) layer (Layer1 or L1) or medium access control (MAC) layer (Layer2 or L2) mobility, updates to system information may be passed as a set of bits indicating one of a plurality of sets predefined system information parameters, which may reduce the overhead entailed in communicating system information updates to a UE.

The following description provides examples and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

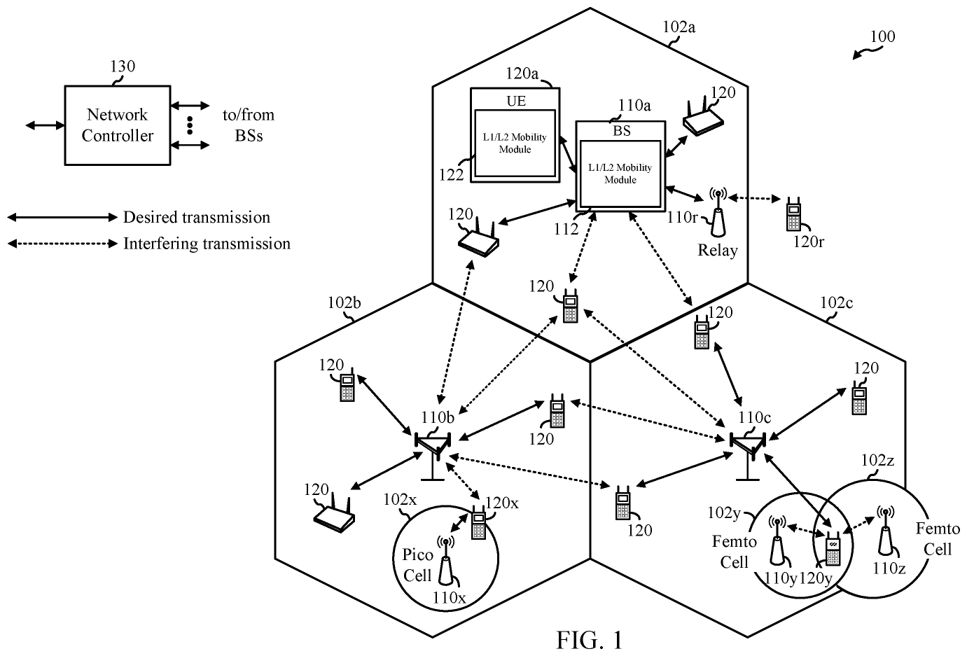

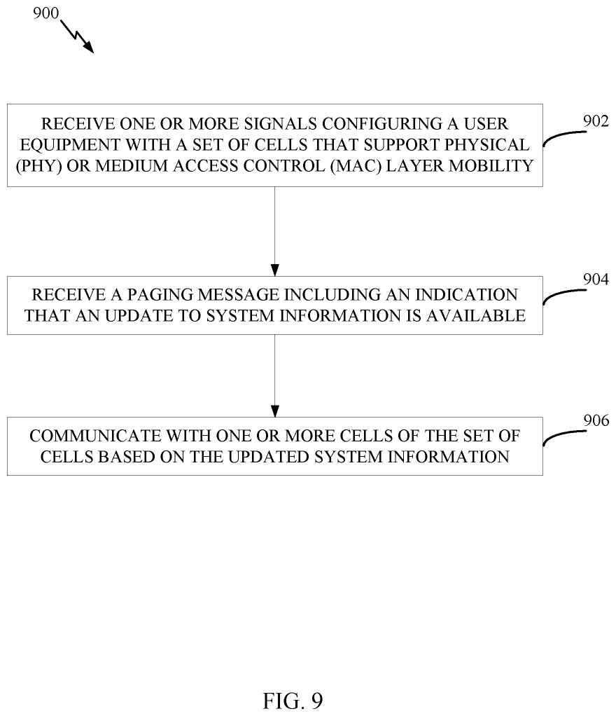

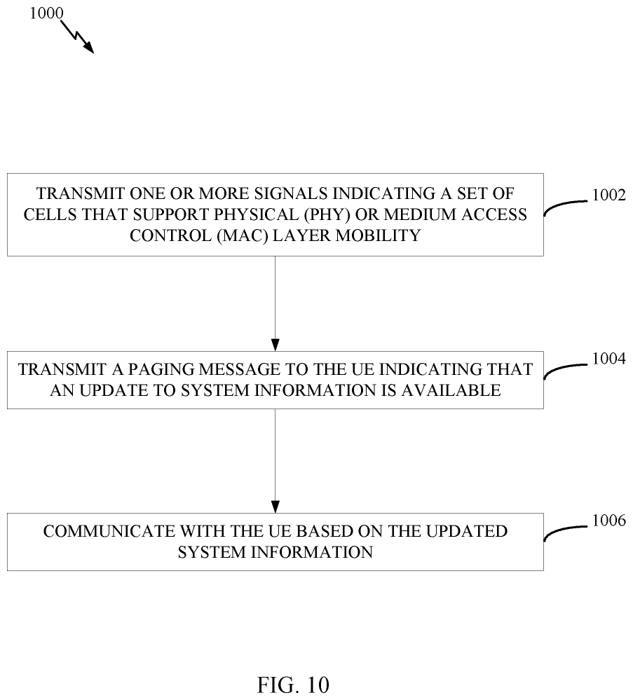

FIG. 1 illustrates an example wireless communication network 100 in which aspects of the present disclosure may be performed. For example, as shown in FIG. 1, UE 120a may include an L1/L2 mobility module 122 that may be configured to perform (or cause UE 120a to perform) operations 900 of FIG. 9. Similarly, a BS 110a may include an L1/L2 mobility module 112 that may be configured to perform (or cause BS 110a to perform) operations 1000 of FIG. 10.

NR access (for example, 5G NR) may support various wireless communication services, such as enhanced mobile broadband (eMBB) targeting wide bandwidth (for example, 80 MHz or beyond), millimeter wave (mmWave) targeting high carrier frequency (for example, 25 GHz or beyond), massive machine type communications MTC (mMTC) targeting non-backward compatible MTC techniques, or mission critical services targeting ultra-reliable low-latency communications (URLLC). These services may include latency and reliability requirements. These services may also have different transmission time intervals (TTI) to meet respective quality of service (QoS) requirements. In addition, these services may co-exist in the same time-domain resource (for example, a slot or subframe) or frequency-domain resource (for example, component carrier).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another or to one or more other BSs or network nodes (not shown) in wireless communication network 100 through various types of backhaul interfaces (for example, a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (for example, 120x, 120y, etc.) may be dispersed throughout the wireless communication network 100, and each UE 120 may be stationary or mobile.

The term “cell” may refer to a logical communication entity used for communication with a base station 110 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area or a portion of a geographic coverage area (e.g., a sector) over which the logical communication entity operates. Such cells may range from smaller areas (e.g., a structure, a subset of structure) to larger areas depending on various factors such as the capabilities of the base station 110. For example, a cell may be or include a building, a subset of a building, or exterior spaces between or overlapping with geographic coverage areas, among other examples.

Wireless communication network 100 may also include relay stations (for example, relay station 110r), also referred to as relays or the like, that receive a transmission of data or other information from an upstream station (for example, a BS 110a or a UE 120r) and sends a transmission of the data or other information to a downstream station (for example, a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (for example, directly or indirectly) via wireless or wireline backhaul.

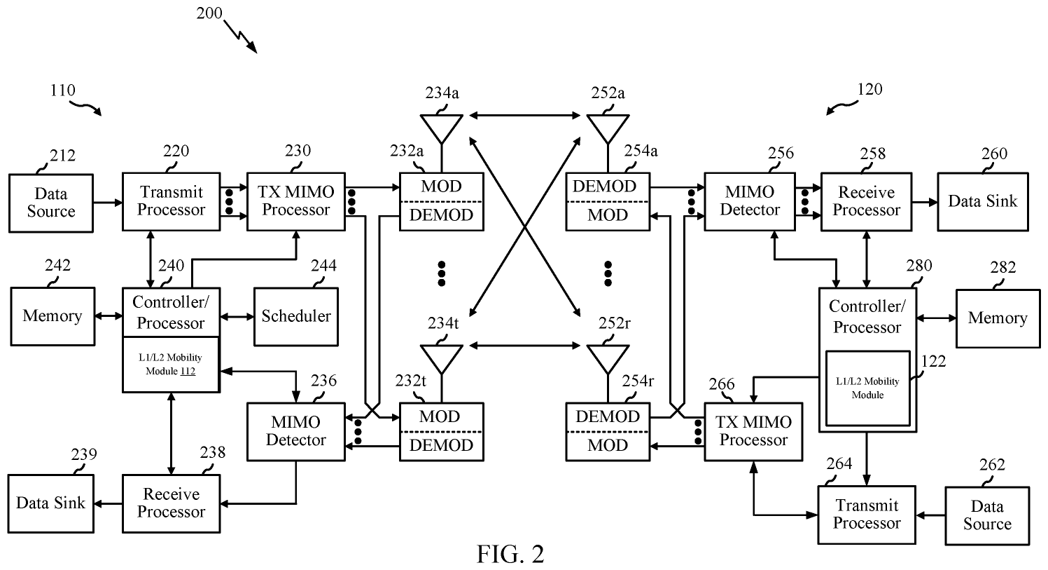

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

The controller/processor 280 or other processors and modules at the UE 120 may perform or direct the execution of processes for the techniques described herein. As shown in FIG. 2, the controller/processor 280 of the UE 120 has an L1/L2 mobility module 122 that may be configured to perform (or cause UE 120 to perform) operations 900 of FIG. 9. Similarly, the BS 110a may include an L1/L2 mobility module 112 that may be configured to perform (or cause BS 110a to perform) operations 1000 of FIG. 10.

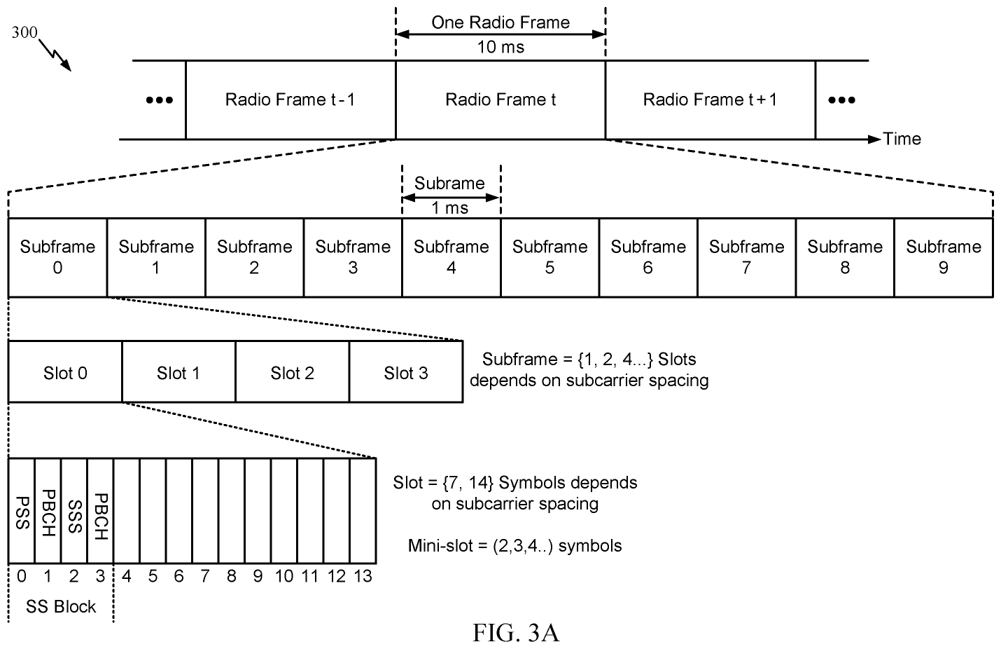

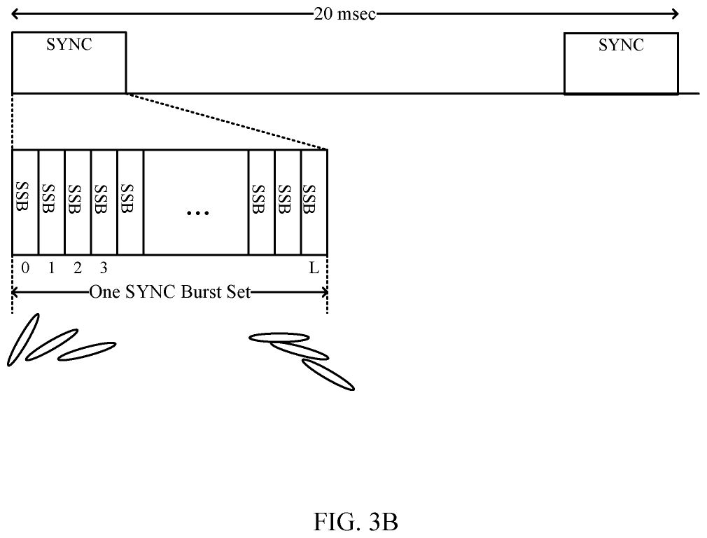

FIG. 3A is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3A. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

As shown in FIG. 3B, the SS blocks may be organized into SS burst sets to support beam sweeping. As shown, each SSB within a burst set may be transmitted using a different beam, which may help a UE quickly acquire both transmit (Tx) and receive (Rx) beams (particular for mmW applications). A physical cell identity (PCI) may still decoded from the PSS and SSS of the SSB.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE. According to aspects of the present disclosure, a CORESET is a set of time and frequency domain resources, defined in units of resource element groups (REGs). Each REG may comprise a fixed number (e.g., twelve) tones in one symbol period (e.g., a symbol period of a slot), where one tone in one symbol period is referred to as a resource element (RE). A fixed number of REGs may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE, and the UE may receive the NR-PDCCH by searching in search spaces for the UE and decoding the NR-PDCCH transmitted by the NodeB.

### Example Methods for L1/L2 Mobility Active Set Management and Cell Synchronization

Aspects of the present disclosure relate to wireless communications, and more particularly, to mobility techniques that allow for dynamically updating a set of cells activated to serve a user equipment (UE) and synchronizing with the set of cells activated to serve the UE. As will be described in greater detail below, the set of activated cells may be updated based on physical (PHY) layer (Layer1 or L1) or medium access control (MAC) layer (Layer2 or L2) signaling that indicates one or more cells to activate and/or de-activate.

The techniques presented herein may be applied in various bands utilized for NR. For example, for the higher band referred to as FR4 (e.g., 52.6 GHz-114.25 GHz), an OFDM waveform with very large subcarrier spacing (960 kHz-3.84 MHz) is required to combat severe phase noise. Due to the large subcarrier spacing, the slot length tends to be very short. In a lower band referred to as FR2 (24.25 GHz to 52.6 GHz) with 120 kHz SCS, the slot length is 125 μSec, while in FR4 with 960 kHz, the slot length is 15.6 μSec.

In multi-beam operation (e.g., involving FR1 and FR2 bands), more efficient uplink/downlink beam management may allow for increased intra-cell and inter-cell mobility (e.g., L1 and/or L2-centric mobility) and/or a larger number of transmission configuration indicator (TCI) states. For example, the states may include the use of a common beam for data and control transmission and reception for UL and DL operations, a unified TCI framework for UL and DL beam indication, and enhanced signaling mechanisms to improve latency and efficiency (e.g., dynamic usage of control signaling).

The techniques presented herein provide signaling mechanisms that may help support such enhanced features, improve latency, and improve efficiency with more usage of dynamic control signaling. For example, the techniques described herein make use of physical layer (PHY, Layer1, or L1) or medium access control (MAC, Layer2 or L2) signaling, as opposed to higher layer (e.g., RRC) signaling.

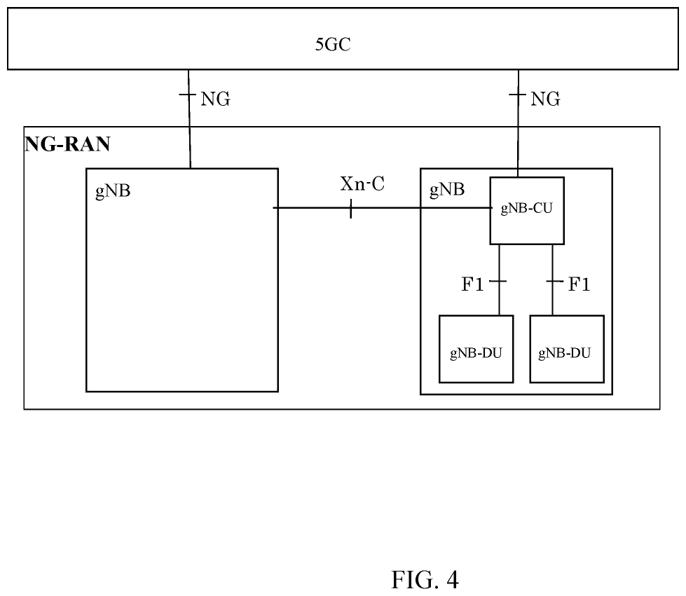

FIG. 4 illustrates an example architecture in which aspects of the present disclosure may be practiced. As illustrated, the architecture includes a gNB Central Unit (gNB-CU). The gNB-CU generally serves as a logical node hosting RRC, Service Data Adaptation Protocol (SDAP) and PDCP protocols of the gNB that controls the operation of one or more gNB distributed units (gNB-DUs). As illustrated, the gNB-CU terminates an F1 interface connected with the gNB-DU.

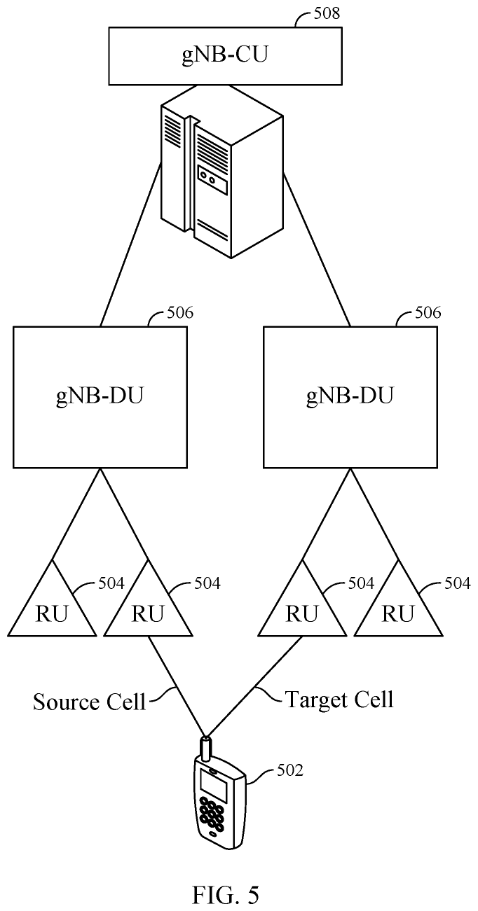

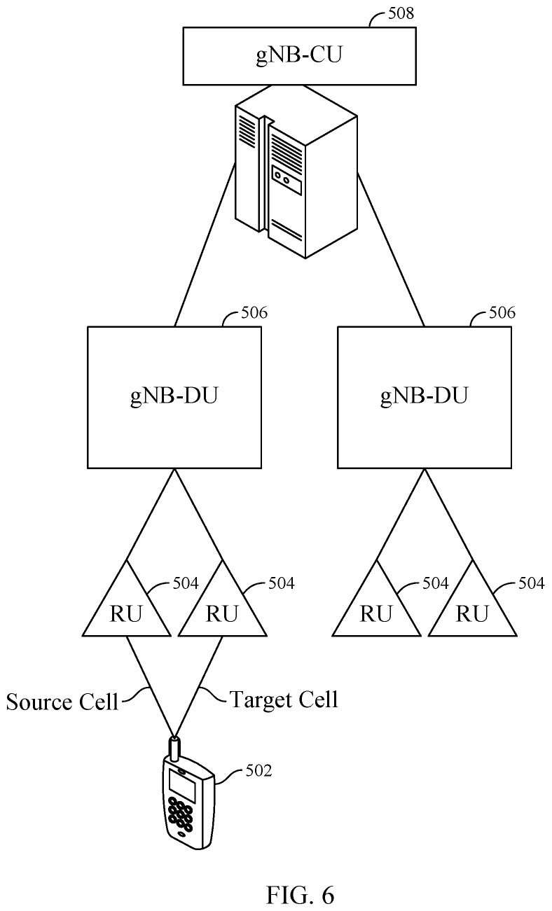

A gNB-DU generally serves as a logical node hosting RLC, MAC and PHY layers of the gNB, and its operation is controlled by gNB-CU. As illustrated in FIGS. 5 and 6, one gNB-DU supports one or multiple cells; however, each cell is supported by only one gNB-DU. The gNB-DU terminates the F1 interface connected with the gNB-CU.

FIGS. 5 and 6 illustrate example scenarios in which aspects of the present disclosure may be practiced.

As illustrated in FIG. 5, in some cases, a UE 502 may be handed over between (source and target) cells supported by radio units, or RUs, 504 of different DUs 506 under the same CU 508. The RUs 504 generally contain only PHY layer logic. In the scenario illustrated in FIG. 5, the cells could have non-collocated (in different DUs) PHY, MAC, and RLC logic, but common PDCP and RRC logic (the same CU). While L1/L2 signaling techniques described herein may be used for mobility, the data path from PDCP to different RLCs present some control aspects that may be addressed by coordination between DUs.

In the scenario illustrated in FIG. 6, on the other hand, source and target cells are supported by (belong to) the same DU. Thus, L1/L2 mobility may be particularly attractive in this scenario, as the cells can share MAC and upper layers (same DU). In this scenario, when performing a handover via L1/L2 signaling, the data path at MAC and above stays the same.

As noted above, the distributed RUs contain only PHY layer and may be used (activated/de-activated) in a similar manner to carrier aggregation (CA), but cells may be on the same carrier frequencies. As such, aspects of the present disclosure, however, may utilize mechanisms similar to those used in CA to enable L1/L1 mobility (e.g., activating/de-activating cells).

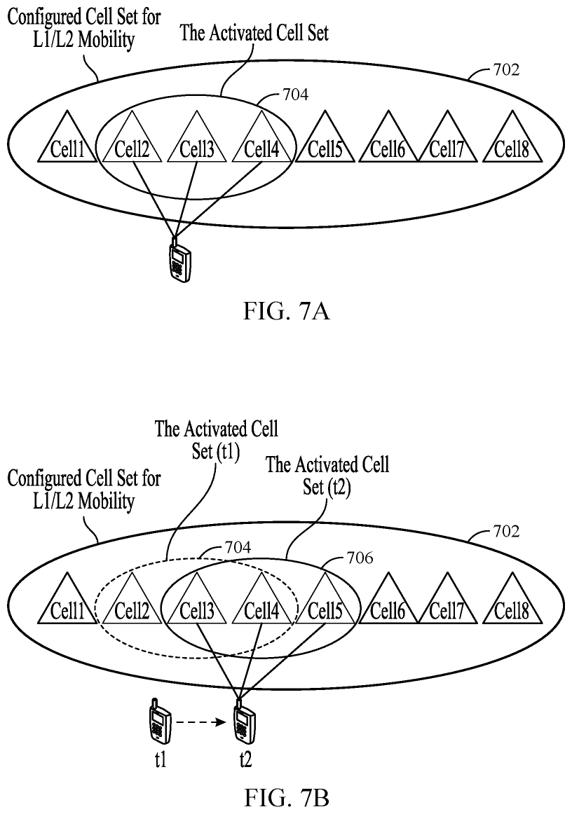

FIG. 7 illustrates an example of UE mobility, in accordance with certain aspects of the present disclosure.

As noted above, as an initial step, RRC signaling may be used to configure a set of cells 702 for L1/L2 mobility. The example of FIG. 7A assumes a configured set of 8 cells (Cells1-8). In general, the cell set may be designed to be large enough to cover meaningful mobility (e.g., anticipated mobility of a UE within a given area and given time). As will be described below, mobility management may be performed by activating/de-activating cells in the set.

From the configured set of cells 702, at any given time, a certain set of cells 704 may be activated. This activated cell set 704 generally refers to a group of cells in the configured set that are activated. Referring again to FIG. 7A, the activated cell set 704 includes Cells 2-4. Which cells are activated for any given UE may depend on UE reported measurements. Configured cells that are not activated (a deactivated cell set) may include the (remaining) group of cells in in the configured set of cells 702 that are deactivated (not activated). In FIG. 7A, the deactivated cell set includes Cell1 and Cells5-8.

Aspects of the present disclosure may provide for seamless mobility within the activated cells in the activated cell set. In some cases, the signaling mechanism may be relatively similar to beam management. For example, mobility management within the activated set may be performed through L1/L2 signaling used to activate/deactivate cells in the activated and deactivated cell sets to select beams within the activated cells.

As illustrated in FIG. 7B, as the UE moves, cells from the configured set of cells 702 are deactivated and activated, for example, based on signal quality (measurements reported by the UE) and other considerations (e.g., loading of the cells). In the example shown in FIG. 7B, as the UE moves from left (at time t1) to right (at time t2), cell 5 (which is now closer) is activated and cell 2 (which is now farther) is de-activated. Thus, after the move, the new activated cell set 706 includes Cell3, Cell4, and Cell5, in contrast to the previous activated cell set 704 which includes Cell2, Cell3, and Cell4.

The cells that are activated/deactivated by L1/L2 signaling may be based on network control, UE recommendation, or UE decision. In general, the L1/L2 signaling (e.g., DCI and/or MAC-CEs) could carry activation and/or deactivation commands (e.g., that indicate cells to be activated and cells to be deactivated).

If a UE is capable of supporting only one activated cell at a time, an activation command indicating a new cell could implicitly deactivate a currently active cell (e.g. upon UE acknowledging the command).

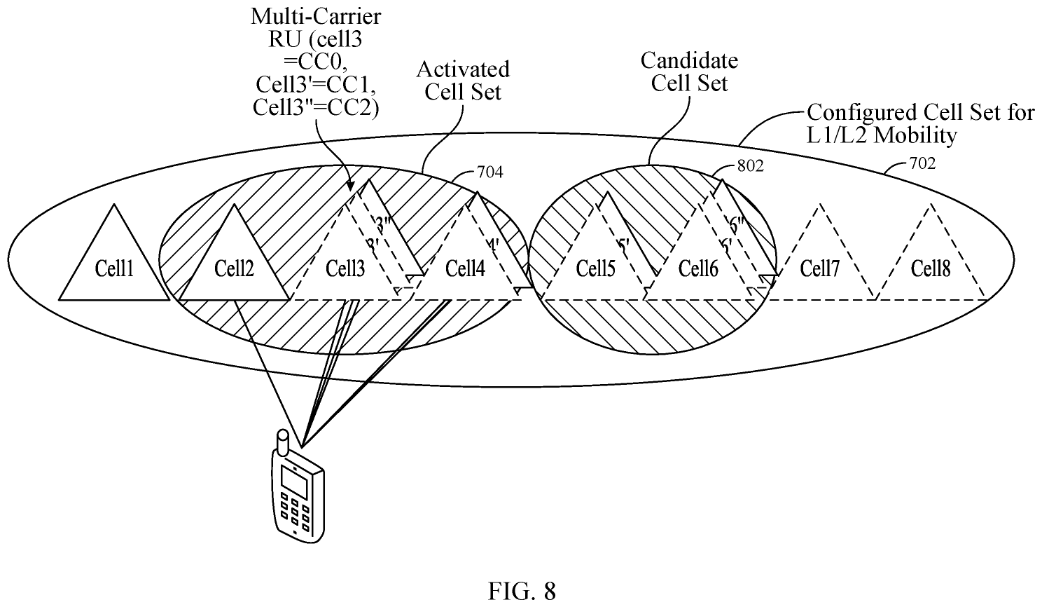

In some cases, one or more of the RUs may have multiple carrier support (with each carrier being a cell). In such cases, activation/deactivation of cells can be done in groups of carriers (cells). For example, referring to FIG. 8, RUs for Cells3-6 assume RUs that support multiple carriers. In the illustrated example, the same RU supports Cell3 (on CC0), Cell3′ (on CC1) and Cell3″ (on CC2). In this example, all three of the cells may be activated, de-activated at the same time. Further, within the set of cells 702, a candidate cell set 802 may be configured. The cells in the candidate cell set 802 may include cells that may be selected as a primary cell for communications with the UE, as discussed herein.

Aspects of the present disclosure may provide for paging of devices that support physical (PHY) layer and/or medium access control (MAC) layer mobility (e.g., L1 or L2 signaling).

FIG. 9 illustrates example operations 900 that may be performed by a UE to update system information based on paging messages transmitted by one or more cells that support PHY layer and/or MAC layer mobility.

As illustrated, operations 900 may begin at block 902, where the UE receives, from a network entity, one or more signals configuring the UE with a set of cells that support physical (PHY) layer or medium access control (MAC) layer mobility. The signaling may be, for example, RRC signaling that may be used to initially configure a UE with information about the set of cells that support PHY or MAC layer mobility signaling (e.g., L1 or L2 mobility signaling). In some aspects, the configuration may be updated (e.g., via L1 or L2 mobility signaling) to activate and/or deactivate cells in the set of cells.

At block 904, the UE receives a paging message including an indication that an update to system information is available. The paging message may be carried, for example, in downlink control information (DCI) messages that indicates that an update to system information is available. As discussed in further detail herein, in some aspects, short messages in particular DCI formats may indicate that emergency messages or updates to system information are available or incoming for the UE. In some aspects, reserved bits in DCI messages may be used to identify an update to system information (e.g., as an identifier of one of a number of preconfigured sets of system information that the UE can use for subsequent communications with cells in the set of cells that support PHY or MAC layer mobility).

At block 906, the UE communicates with one or more of the set of cells based on the updated system information. In some aspects, the UE may decode a subsequent paging message carrying information for the UE (e.g., emergency messages, or other information paged to the UE). In some aspects, the UE may change how it communicates with and encodes and/or decodes messages to and/or from the base station based on the updated system information.

FIG. 10 illustrates example operations 1000 that may be performed by a network entity to update system information based on paging messages for one or more cells that support PHY layer and/or MAC layer mobility.

As illustrated, operations 1000 may begin at block 1002, where the network entity transmits, to a UE, one or more signals indicating a set of cells that support physical (PHY) or medium access control (MAC) layer mobility. The one or more signals may include, for example, RRC signaling that may be transmitted by the network entity to initially configure a UE with information about the set of cells that support PHY or MAC layer mobility signaling (e.g., L1 or L2 mobility signaling). In some aspects, the configuration may be updated by the network entity (e.g., via L1 or L2 mobility signaling) to activate and/or deactivate cells in the set of cells.

At block 1004, the network entity transmits a paging message to the UE indicating that an update to system information is available. As discussed, the paging message may be transmitted in downlink control information (DCI) messages that indicates that an update to system information is available. For example, short messages in particular DCI formats may indicate that emergency messages or updates to system information are available or incoming for the UE, or reserved bits in DCI messages may identify an update to system information (e.g., as an identifier of one of a number of preconfigured sets of system information that the UE can use for subsequent communications with cells in the set of cells that support PHY or MAC layer mobility).

At block 1006, the network entity communicates with the UE based on the updated system information. In some aspects, the network entity may transmit subsequent paging messages to the UE based on an indication that emergency messages are available for the UE. In some aspects, the network entity may page the UE with other information, and the paging transmitted by the network entity may be encoded and/or decoded based on a system information configuration identified in the paging message transmitted to the UE at block 1004.

In some aspects, a short message in downlink control information (DCI) Format 1_0 may indicate that a system information update is available or may indicate that an emergency message (e.g., an earthquake and tsunami warning service (ETWS) message or a commercial mobile alert system (CMAS) message) is incoming. The short message may be scrambled, in some aspects, using, for example, a paging radio network temporary identifier (P-RNTI). When a UE receives the short message, the UE can de-scramble the message using the P-RNTI to recover at least an indication of whether system information updates or incoming emergency messages are awaiting the UE, as discussed in further detail below

The DCI Format 1_0 message may include a number of reserved bits that may be used to indicate the system information parameters to be used by a UE for subsequent communications for one or more cells that support PHY or MAC layer mobility. For example, six reserved bits may be used, with unique combinations of the six reserved bits serving as a bitmap identifying a specific combination of system information parameters to be applied to for subsequent communications with the one or more cells. In some aspects, the UE may be preconfigured with the plurality of combinations of system information parameters and mappings between each combination and a value of the reserved bits.

In some aspects, the DCI Format 1_0 message may include a single reserved bit that indicates whether an assigned physical downlink shared channel (PDSCH) contains a medium access control (MAC) control element (CE) that includes the updated system information. If the short message includes the single reserved bit set to high (i.e., a value of “1” for the reserved bit), the UE can monitor the PDSCH for a MAC CE including an system information update. In some aspects, the MAC CE including the system information update may include a plurality of reserved bits, with each unique combination of values for the plurality of reserved bits being mapped to a specific combination of system information parameters (with which the UE may be configured by one or more other messages transmitted from one of the one or more cells to the UE).

In some aspects, the DCI message may include only the short message indicating that a system information update is available. In such a case, reserved bits in the DCI message for allocating certain resources to the UE (e.g., reserved bits used to indicate an allocation of resources for a PDSCH) can be used to indicate that a system information update is pending for the UE. The indication may, for example, be a pointer to a PDSCH resource that carries information identifying one of a plurality of preconfigured sets of system information parameters to be used by the UE for communications with one or more cells of the set of cells that support PHY or MAC layer mobility. In some aspects, the indication may be a series of bits that identify one of a plurality of preconfigured sets of system information parameters to be used by the UE for communications with one or more cells of the set of cells that support PHY or MAC layer mobility

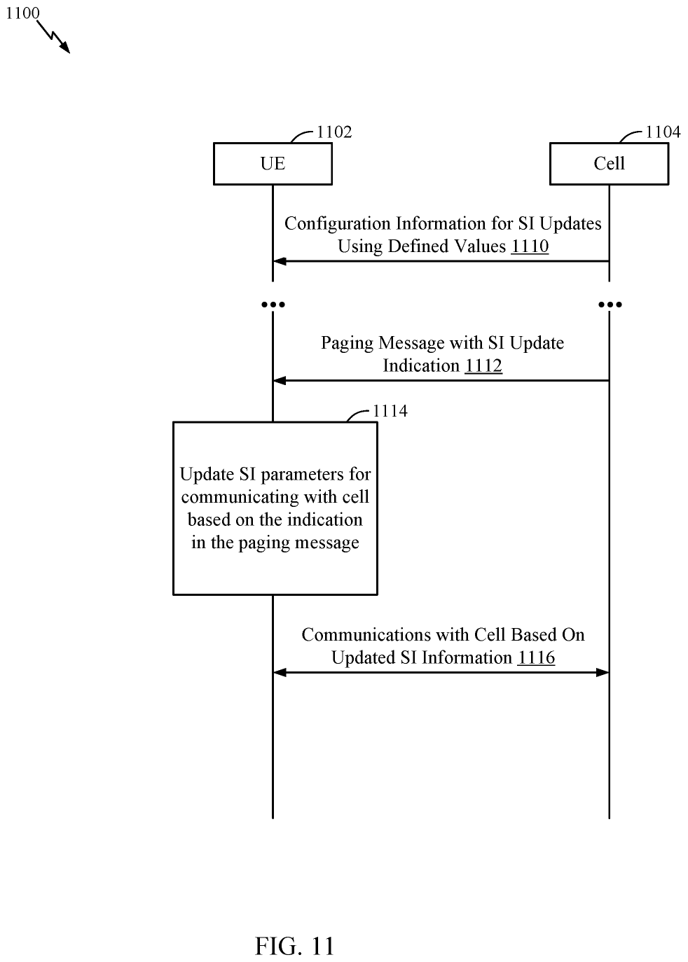

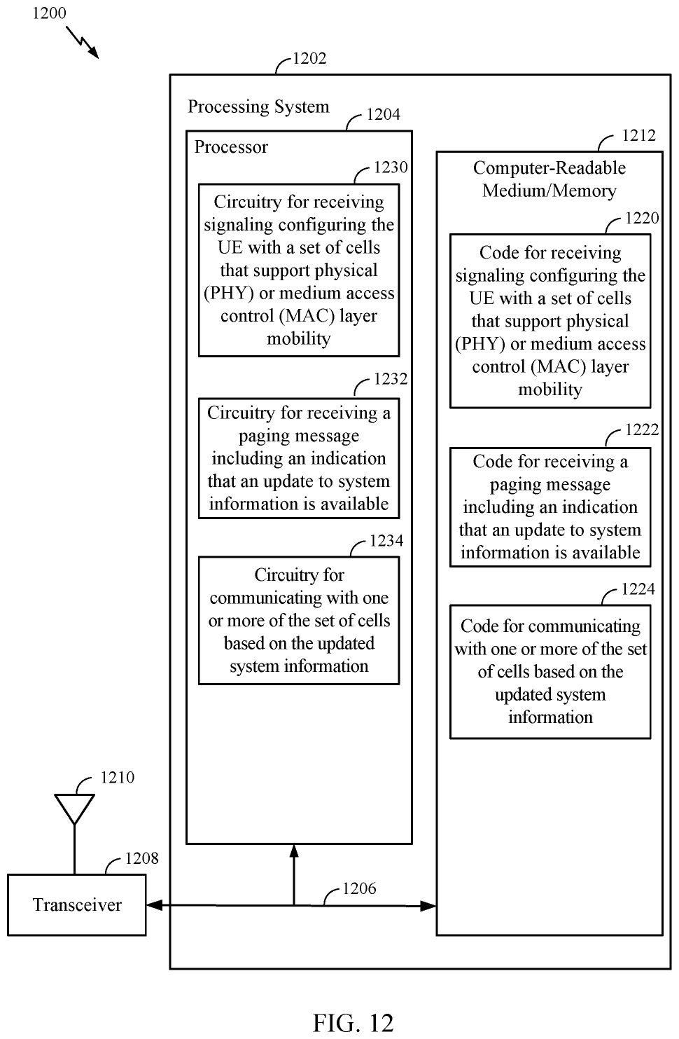

FIG. 11 is a call flow diagram 1100 illustrating messages that may be exchanged between a UE 1102 and a cell 1104 to convey and use system information updates in communications between the UE 1102 and the cell 1104. As discussed above, cell 1104 may be a cell included in a group of cells that support PHY layer or MAC layer mobility.

As illustrated, a UE 1102 receives configuration information 1110 for system information updates using defined values. These defined values may include, for example, sets of system information (SI) values. Each unique set of SI values may be associated, for example, with an indicator used to identify which set of SI values to apply to communications between UE 1102 and cell 1104 (and other cells that support PHY layer or MAC layer mobility).

Subsequently, UE 1102 may receive a paging message 1112 from cell 1104. The paging message may be carried, for example, in a DCI message or other messaging indicating that an update to system information is available or is otherwise to be implemented for subsequent communications between the UE 1102 and one or more cells (e.g., cell 1104 and other cells in an active cell group in which the cells support PHY layer or MAC layer mobility). In some aspects, the paging message may include an indication of a system information update. This indication may include, for example, an identifier associated with a set of SI values to apply to subsequent communications, according to the configuration information 1110 provided to UE 1102 from cell 1104.

Based on the indication carried in paging message 1112, at block 1114, the UE 1102 updates SI parameters for communicating with the cell 1104 (and, in some cases, other cells in an active cell group of cells that support PHY layer or MAC layer mobility). Subsequent communications 1116 between the UE 1102 and cell 1104 may be performed based on the updated SI information.

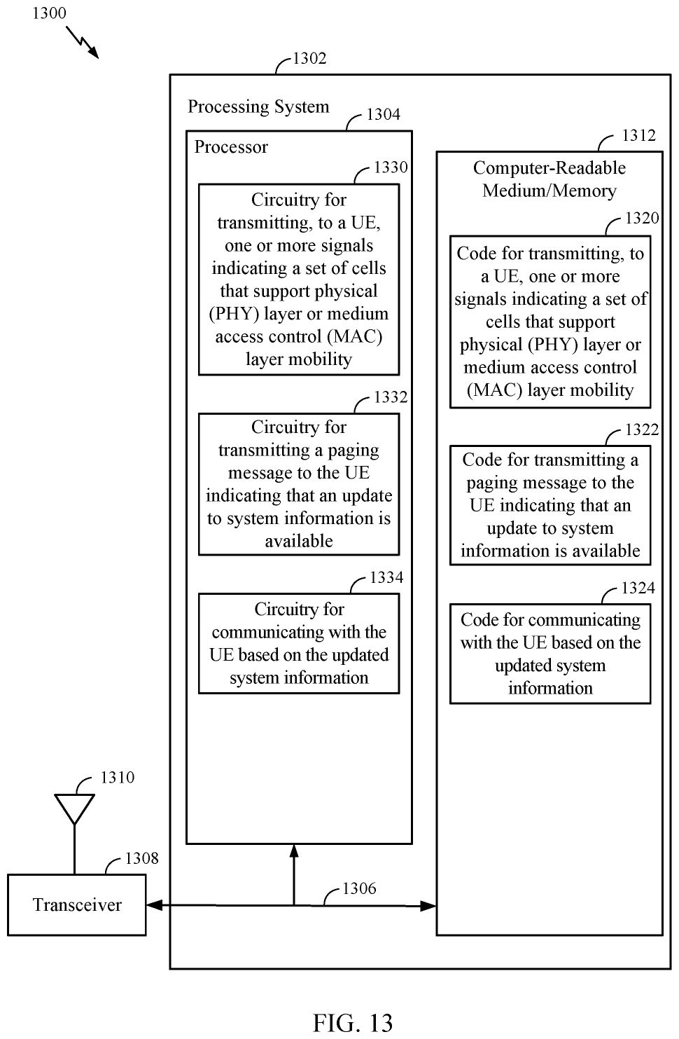

FIG. 13 illustrates a communications device 1300 that may include various components (e.g., corresponding to means-plus-function components) configured to perform operations for the techniques disclosed herein, such as the operations illustrated in FIG. 9. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 9, or other operations for performing the various techniques discussed herein for updating system information based on paging messages transmitted by cells that support PHY layer or MAC layer mobility. In certain aspects, computer-readable medium/memory 1312 stores code 1320 for receiving signaling configuring the UE with a set of cells that support physical (PHY) or medium access control (MAC) layer mobility; code 1322 for receiving a paging message including an indication that an update to system information is available; and code 1324 for communicating with one or more of the set of cells based on the updated system information. In certain aspects, the processor 1304 has circuitry configured to implement the code stored in the computer-readable medium/memory 1312. The processor 1304 includes circuitry 1330 for receiving signaling configuring the UE with a set of cells that support physical (PHY) or medium access control (MAC) layer mobility; circuitry 1332 for receiving a paging message including an indication that an update to system information is available; and circuitry 1334 for communicating with one or more of the set of cells based on the updated system information.

FIG. 13 illustrates a communications device 1300 that may include various components (e.g., corresponding to means-plus-function components) configured to perform operations for the techniques disclosed herein, such as the operations illustrated in FIG. 10. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 10, or other operations for performing the various techniques discussed herein for updating system information based on paging messages transmitted by cells that support PHY layer or MAC layer mobility. In certain aspects, computer-readable medium/memory 1312 stores code 1320 for transmitting, to a UE, one or more signals indicating a set of cells that support physical (PHY) layer or medium access control (MAC) layer mobility; code 1322 for transmitting a paging message to the UE indicating that an update to system information is available; and code 1324 for communicating with the UE based on the updated system information. In certain aspects, the processor 1304 has circuitry configured to implement the code stored in the computer-readable medium/memory 1312. The processor 1304 includes circuitry 1330 for transmitting, to a UE, one or more signals indicating a set of cells that support physical (PHY) layer or medium access control (MAC) layer mobility; circuitry 1332 for transmitting a paging message to the UE indicating that an update to system information is available; and circuitry 1334 for communicating with the UE based on the updated system information.

### Example Clauses

Clause 1: A method for wireless communications by a user equipment (UE), comprising: receiving one or more signals configuring the UE with a set of cells that support physical (PHY) layer or medium access control (MAC) layer mobility; receiving a paging message including an indication that an update to system information is available; and communicating with one or more of the set of cells based on the updated system information.

Clause 2: The method of Clause 1, wherein the set of cells are supported by one or more distributed units (DUs) under a common central unit (CU).

Clause 3: The method of Clause 2, wherein: the one or more DUs comprises a common DU that supports each cell of the set of cells.

Clause 4: The method of any one of Clauses 1 through 3, wherein the UE is in a connected state when receiving the paging message.

Clause 5: The method of any one of Clauses 1 through 4, wherein the paging message including the indication that an update to system information is available comprises a short message scrambled by a paging radio network temporary identifier (P-RNTI).

Clause 6: The method of Clause 5, wherein the short message comprises a number of reserved bits used to indicate one of a plurality of system information configurations to apply for communications with the one or more of the set of cells.

Clause 7: The method of Clause 6, wherein the reserved bits indicate one of the plurality of system information configurations when the short message includes an indication of a system information change.

Clause 8: The method of any one of Clauses 6 or 7, further comprising: receiving, from one or more cells in the set of cells, configuration information including a plurality of preconfigured system information configurations, each one of the plurality of preconfigured system information configurations being associated with a unique value for the number of reserved bits.

Clause 9: The method of any one of Clauses 6 through 8, wherein the reserved bits indicate whether a physical downlink shared channel (PDSCH) contains a MAC control element (CE) with an indication of one of a plurality of system information configurations to apply for communications with the one or more of the set of cells.

Clause 10: The method of any one of Clauses 1 through 9, wherein reserved bits in the paging message include the indication that an update to system information is available.

Clause 11: The method of Clause 10, wherein the reserved bits comprise bits identifying a physical downlink shared channel (PDSCH) allocation.

Clause 12: The method of any one of Clauses 10 or 11, wherein the indication comprises a pointer to a physical downlink shared channel (PDSCH) that carries information about one of a plurality of system information configurations to apply for communications with the one or more of the set of cells.

Clause 13: The method of any one of Clauses 10 through 12, wherein the reserved bits in the paging message include an indication of one of a plurality of system information configurations to apply for communications with the one or more of the set of cells.

Clause 14: A method for wireless communications by a network entity, comprising: transmitting, to a user equipment (UE), one or more signals indicating a set of cells that support physical (PHY) layer or medium access control (MAC) layer mobility; transmitting, to the UE, a paging message indicating that an update to system information is available; and communicating with the UE based on the updated system information.

Clause 15: The method of Clause 14, wherein the set of cells are supported by one or more distributed units (DUs) under a common central unit (CU).

Clause 16: The method of Clause 15, wherein: the one or more DUs comprises a common DU that supports each cell of the set of cells.

Clause 17: The method of Clause 14, wherein the paging message including the indication that an update to system information is available comprises a short message scrambled by a paging radio network temporary identifier (P-RNTI).

Clause 18: The method of Clause 17, wherein the short message comprises a number of reserved bits used to indicate one of a plurality of system information configurations to apply for communications with the one or more of the set of cells.

Clause 19: The method of Clause 18, wherein the reserved bits indicate one of the plurality of system information configurations when the short message includes an indication of a system information change.

Clause 20: The method of any one of Clauses 18 or 19, further comprising: transmitting, to the UE, configuration information including a plurality of preconfigured system information configurations, each one of the plurality of preconfigured system information configurations being associated with a unique value for the number of reserved bits.

Clause 21: The method of any one of Clauses 18 through 20, wherein the reserved bits indicate whether a physical downlink shared channel (PDSCH) contains a MAC control element (CE) with an indication of one of a plurality of system information configurations to apply for communications with the one or more of the set of cells.

Clause 22: The method of any one of Clauses 14 through 21, wherein reserved bits in the paging message include the indication that an update to system information is available.

Clause 23: The method of Clause 22, wherein the reserved bits comprise bits identifying a physical downlink shared channel (PDSCH) allocation.

Clause 24: The method of any one of Clauses 22 or 23, wherein the indication comprises a pointer to a physical downlink shared channel (PDSCH) that carries information about one of a plurality of system information configurations to apply for communications with the one or more of the set of cells.

Clause 25: The method of any one of Clauses 22 through 24, wherein the reserved bits in the paging message include an indication of one of a plurality of system information configurations to apply for communications with the one or more of the set of cells.

Clause 26: An apparatus, comprising: a memory having executable instructions stored thereon; and a processor configured to execute the executable instructions to cause the apparatus to perform the operations of any one of Clauses 1 through 25.

Clause 27: An apparatus, comprising: means for performing the operations of any one of Clauses 1 through 25.

Clause 28: A computer-readable medium having instructions stored thereon which, when executed by a processor, performs the operations of any one of Clauses 1 through 25.

### Additional Considerations

The techniques described herein may be used for various wireless communication technologies, such as NR (for example, 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, or 5G wireless technologies, aspects of the present disclosure can be applied in other generation-based communication systems.

In 3GPP, the term “cell” can refer to a coverage area of a Node B (NB) or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, or other types of cells. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having an association with the femto cell (for example, UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (for example, a smart ring, a smart bracelet, etc.), an entertainment device (for example, a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, which may be narrowband IoT (NB-IoT) devices.

Some wireless networks (for example, LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (for example, 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (for example, 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (for example, a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (for example, one or more other UEs), and the other UEs may utilize the resources scheduled by the UE for wireless communication. In some examples, a UE may function as a scheduling entity in a peer-to-peer (P2P) network, or in a mesh network. In a mesh network example, UEs may communicate directly with one another in addition to communicating with a scheduling entity.

As used herein, the term “determining” may encompass one or more of a wide variety of actions. For example, “determining” may include calculating, computing, processing, deriving, investigating, looking up (for example, looking up in a table, a database or another data structure), assuming and the like. Also, “determining” may include receiving (for example, receiving information), accessing (for example, accessing data in a memory) and the like. Also, “determining” may include resolving, selecting, choosing, establishing and the like.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communications by a user equipment (UE), comprising:
receiving one or more signals configuring the UE with a set of cells that support physical (PHY) layer or medium access control (MAC) layer mobility;
receiving a paging message including an indication that an update to system information is available; and
communicating with one or more of the set of cells based on the updated system information.

2. The method of claim 1, wherein the set of cells are supported by one or more distributed units (DUs) under a common central unit (CU).

3. The method of claim 2, wherein:
the one or more DUs comprises a common DU that supports each cell of the set of cells.

4. The method of claim 1, wherein the UE is in a connected state when receiving the paging message.

5. The method of claim 1, wherein the paging message including the indication that an update to system information is available comprises a short message scrambled by a paging radio network temporary identifier (P-RNTI).

6. The method of claim 5, wherein the short message comprises a number of reserved bits used to indicate one of a plurality of system information configurations to apply for communications with the one or more of the set of cells.

7. The method of claim 6, wherein the reserved bits indicate one of the plurality of system information configurations when the short message includes an indication of a system information change.

8. The method of claim 6, further comprising:
receiving, from one or more cells in the set of cells, configuration information including a plurality of preconfigured system information configurations, each one of the plurality of preconfigured system information configurations being associated with a unique value for the number of reserved bits.

9. The method of claim 6, wherein the reserved bits indicate whether a physical downlink shared channel (PDSCH) contains a MAC control element (CE) with an indication of one of a plurality of system information configurations to apply for communications with the one or more of the set of cells.

10. The method of claim 1, wherein reserved bits in the paging message include the indication that an update to system information is available.

11. The method of claim 10, wherein the reserved bits comprise bits identifying a physical downlink shared channel (PDSCH) allocation.

12. The method of claim 10, wherein the indication comprises a pointer to a physical downlink shared channel (PDSCH) that carries information about one of a plurality of system information configurations to apply for communications with the one or more of the set of cells.

13. The method of claim 10, wherein the reserved bits in the paging message include an indication of one of a plurality of system information configurations to apply for communications with the one or more of the set of cells.

14. A method for wireless communications by a network entity, comprising:
transmitting, to a user equipment (UE), one or more signals indicating a set of cells that support physical (PHY) layer or medium access control (MAC) layer mobility;
transmitting, to the UE, a paging message indicating that an update to system information is available; and
communicating with the UE based on the updated system information.

15. The method of claim 14, wherein the set of cells are supported by one or more distributed units (DUs) under a common central unit (CU).

16. The method of claim 15, wherein:
the one or more DUs comprises a common DU that supports each cell of the set of cells.

17. The method of claim 14, wherein the paging message including the indication that an update to system information is available comprises a short message scrambled by a paging radio network temporary identifier (P-RNTI).

18. The method of claim 17, wherein the short message comprises a number of reserved bits used to indicate one of a plurality of system information configurations to apply for communications with the one or more of the set of cells.

19. The method of claim 18, wherein the reserved bits indicate one of the plurality of system information configurations when the short message includes an indication of a system information change.

20. The method of claim 18, further comprising:
transmitting, to the UE, configuration information including a plurality of preconfigured system information configurations, each one of the plurality of preconfigured system information configurations being associated with a unique value for the number of reserved bits.

21. The method of claim 18, wherein the reserved bits indicate whether a physical downlink shared channel (PDSCH) contains a MAC control element (CE) with an indication of one of a plurality of system information configurations to apply for communications with the one or more of the set of cells.

22. The method of claim 14, wherein reserved bits in the paging message include the indication that an update to system information is available.

23. The method of claim 22, wherein the reserved bits comprise bits identifying a physical downlink shared channel (PDSCH) allocation.

24. The method of claim 22, wherein the indication comprises a pointer to a physical downlink shared channel (PDSCH) that carries information about one of a plurality of system information configurations to apply for communications with the one or more of the set of cells.

25. The method of claim 22, wherein the reserved bits in the paging message include an indication of one of a plurality of system information configurations to apply for communications with the one or more of the set of cells.

26. An apparatus for wireless communications by a user equipment (UE), comprising:
at least one processor configured to:
receive one or more signals configuring the UE with a set of cells that support physical (PHY) layer or medium access control (MAC) layer mobility;
receive a paging message including an indication that an update to system information is available; and
communicate with one or more of the set of cells based on the updated system information; and
a memory coupled with the at least one processor.

27. An apparatus for wireless communications by a network entity, comprising:
at least one processor configured to:
transmit, to a user equipment (UE), one or more signals indicating a set of cells that support physical (PHY) layer or medium access control (MAC) layer mobility;
transmit, to the UE, a paging message indicating that an update to system information is available; and
communicate with the UE based on the updated system information; and
a memory coupled with the at least one processor.
